(19) United States
(12) Patent Application Publication
(10) Pub. No.: US 2011/0222305 A1
(43) Pub. Date: Sep. 15, 2011

(54) LED CAR LAMP STRUCTURE WITH DEMISTING AND DEHUMIDIFY FUNCTIONS

(75) Inventor: Chiu-Mao Huang, Sinjhuang City (TW)

(73) Assignee: ASIA VITAL COMPONENTS CO., LTD., Sinjhuang City (TW)

(21) Appl. No.: 12/753,088

(22) Filed: Apr. 1, 2010

(30) Foreign Application Priority Data
Mar. 11, 2010 (TW) 099204316

(51) Int. Cl. F21V 5/00

(52) U.S. Cl. 362/520; 362/547

(57) ABSTRACT

An LED car lamp structure with demisting and dehumidifying functions includes a car lamp assembly, at least one LED module, and at least one fan. The car lamp assembly includes a base and a light-transmitting lens connected to a front side of the base, so that the lens and the base form an integral body and define a closed chamber in between them. The LED module is connected to the base and has a plurality of LEDs oriented to the lens, so that light beams emitted from the LEDs are transmitted through the lens to external environment. The fan is connected to the base and located in the closed chamber. When the fan is started, air in the closed chamber is forced to flow and circulate therein, so that the closed chamber has evenly distributed temperature therein to prevent mists and condensate from forming in the car lamp assembly.

This application claims the priority benefit of Taiwan patent application number 099204316 filed on Mar. 11, 2010.

### FIELD OF THE INVENTION

The present invention relates to an LED car lamp structure, and more particularly to an LED car lamp structure with demisting and dehumidifying functions.

### BACKGROUND OF THE INVENTION

Light-emitting diodes (LEDs) have the advantages of low power consumption, long service life, etc., and are widely used in various types of light emitting devices as the light sources thereof. Currently, high-power LEDs are also used as light sources in car lamps.

A conventional car lamp structure using LEDs as the light sources thereof includes a lens and a base. The lens and the base are connected to each other to form an integral body and define a closed space in between them. At least one LED unit is mounted on the base to locate in the closed space, so that light beams from the LED unit are emitted toward the lens. In manufacturing the car lamp structure using LEDs as the light sources thereof, the space defined in between the base and the lens is fully closed but not vacuumed. Therefore, there is still a small amount of air and moisture left in the conventional LED car lamp structure. The air and moisture left in the conventional LED car lamp tend to be affected by temperature or weather conditions, such as in a rainy day or a humid morning. Car wash also has influence on the conventional LED car lamp because water might invade in the car lamp. Cold air, moisture, or water droplets in the car lamp would form mists or condensate, which are attached to an inner surface of the lens of the car lamp. A user needs to turn on the car lamp for light beams to transmit through the lens to external environment while gradually removing the mists or the condensate from the lens.

It is noted the emitted light beams are concentrated on only a small area on the lens when they transmit through the lens, and heat produced by the light sources tend to gather at the same small area. While the heat gathered at this small area gradually vaporizes the mists or the condensate, other areas of the lens surrounding the central small area and farther away from the light sources still have low temperature. Further, there is a relatively large temperature difference between the inner and the outer environment of the car lamp. These factors would cause the remained moisture in the car lamp to form mists or condensate, which in turn reduces the brightness and illumination area of the light beams emitted from the car lamp. The mists and moisture in the car lamp would also cause failure or damage to the LEDs and adversely affect the exterior appearance of the car lamp.

It is therefore tried by the inventor to develop an improved LED car lamp structure with demisting and dehumidifying functions to overcome the disadvantages in the conventional LED car lamps.

### SUMMARY OF THE INVENTION

A primary of the present invention is to provide an LED car lamp structure with demisting and dehumidifying functions, so that air in a closed chamber defined in an LED car lamp is forced by a fan to flow and circulate in the closed chamber, allowing the closed chamber to have evenly distributed temperature therein to avoid forming mists and condensate in the LED car lamp.

To achieve the above and other objects, the LED car lamp structure with demisting and dehumidifying functions according to the present invention includes a car lamp assembly, at least one LED module, and at least one fan. The car lamp assembly includes a base and a light-transmitting lens, the lens is connected to and located in front of the base, so that the lens and the base form an integral body and define a closed chamber in between them. The LED module includes a main seat connected to the base of the car lamp assembly, and a plurality of LEDs mounted on the main seat. The LEDs respectively have a light-emitting end oriented to the lens of the car lamp assembly, so that light beams emitted from the LEDs are transmitted from the light-emitting ends through the lens to external environment. The fan is connected to the base of the car lamp assembly and located in the closed chamber for forcing air in the closed chamber to flow and circulate therein.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a partially sectioned side view of an LED car lamp structure with demisting and dehumidifying functions according to a preferred embodiment of the present invention;

FIG. 2 is a front view of FIG. 1;

FIG. 3 is a partially sectioned side view showing the LED car lamp structure with demisting and dehumidifying functions according to the present invention has a heat sink connected thereto; and

FIG. 4 is another partially sectioned side view showing the LED car lamp structure with demisting and dehumidifying functions according to the present invention is connected to a controller.

### DETAILED DESCRIPTION OF THE PREFERRED EMBODIMENTS

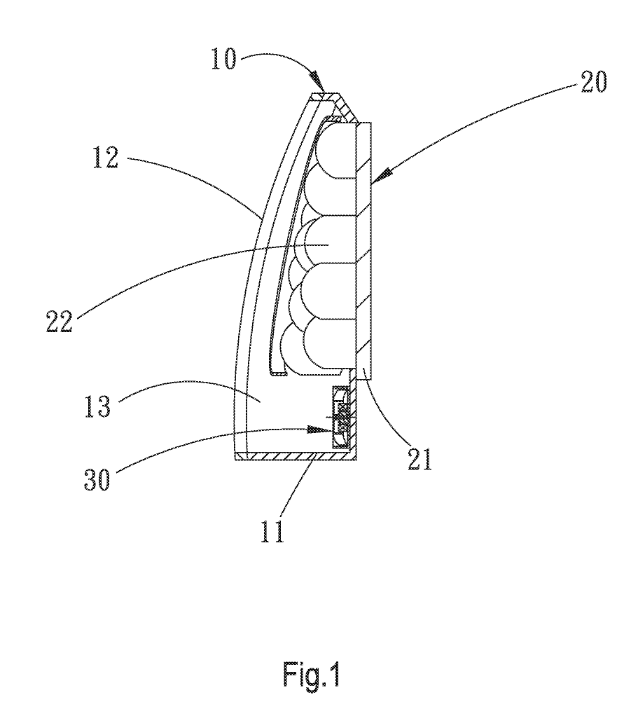

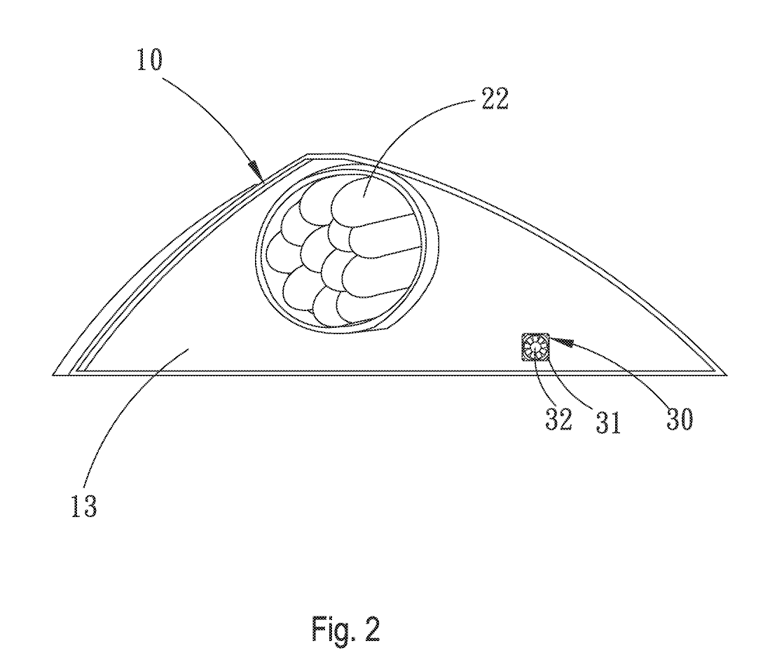

Please refer to FIGS. 1 and 2 that are partially sectioned side view and front view of an LED car lamp structure with demisting and dehumidifying functions according to a preferred embodiment of the present invention. As shown, the LED car lamp structure of the present invention includes a car lamp assembly 10, at least one light-emitting diode (LED) module 20, and at least one fan 30.

The car lamp assembly 10 includes a base 11 and a light-transmitting lens 12. The lens 12 is connected to and located in front of the base 11, so that the lens 12 and the base 11 form an integral body and define a closed chamber 13 in between them.

The LED module 20 has a main seat 21 connected to the base 11, and a plurality of LEDs 22 mounted on the main seat 21. The LEDs 22 respectively have a light-emitting end oriented to the lens 12, so that light beams emitted from the LEDs 22 are transmitted from the light-emitting ends through the lens 12 to external environment.

The fan 30 is mounted on the base 11 and located in the closed chamber 13. While the fan 30 illustrated in FIG. 2 is mounted on the right portion of the base 11 when viewing in front of the car lamp assembly 10, it is understood the fan 30 can be mounted on the base 11 at any other position, so long as the fan 30 does not interfere with the LED module 20. The fan 30 can be an axial fan or a centrifugal fan. The fan 30 illustrated in FIG. 2 is an axial fan, and has a frame 31 and a blade assembly 32 located in and rotatably connected to the frame 31.

When the car lamp assembly 10 is enabled, light beams are concentrated on and emitted from the light-emitting ends of the LEDs 22 to transmit through the lens 12 to external environment. The fan 30 can start operating at the same time or before or after the car lamp assembly 10 is enabled. With the operation of the fan 30, air in the closed chamber 13 flows and circulates therein without flowing to external environment. As a result, the air and temperature in the closed chamber 13 are evenly distributed, preventing mists and condensate from forming on areas of the lens 12 that are farther away from the LED module 20 and not irradiated by the emitted light beams.

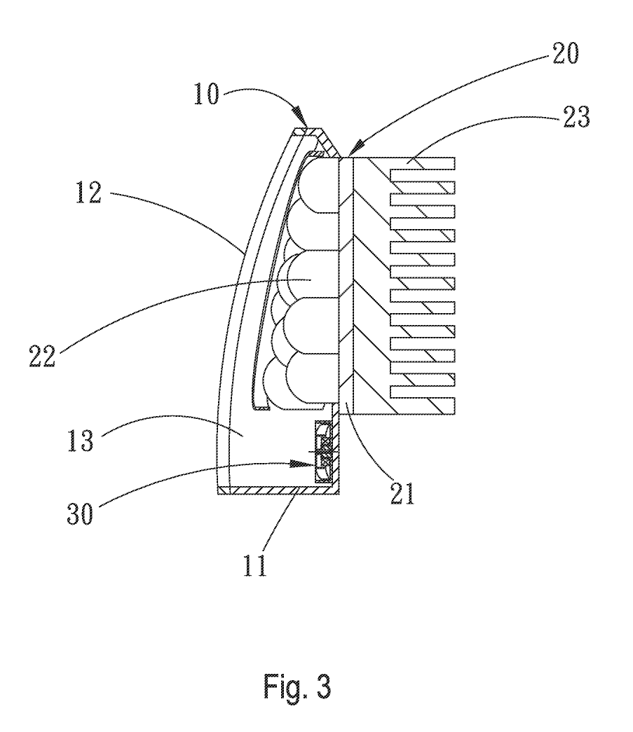

FIG. 3 shows a heat sink 23 can be externally connected to the main seat 21 of the LED module 20 for dissipating heat produced by the LED module 20 into external environment.

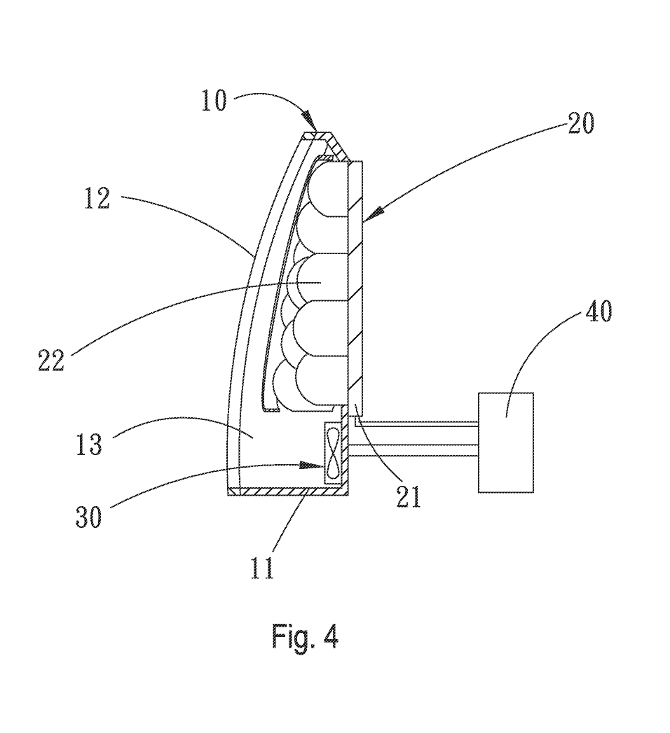

FIG. 4 shows the LED module 20 and the fan 30 are electrically connected to a controller 40, so that the LED module 20 and the fan 30 can be controlled to turn on or off via the controller 40.

With the above arrangements, the LED car lamp structure according to the present invention is improved and superior to the conventional car lamps for the following reason: the fan 30 forces the air in the closed chamber 13 to flow and the air does not flow to external environment but circulates in the closed chamber 13, so that the air and different areas in the closed chamber 13 can have evenly distributed temperature to prevent mists or condensate from forming on an inner surface of the lens 12 due to temperature difference.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An LED car lamp structure with demisting and dehumidifying functions, comprising:
a car lamp assembly including a base and a light-transmitting lens; the lens being connected to and located in front of the base, so that the lens and the base form an integral body and define a closed chamber in between them;
at least one LED module including a main seat connected to the base of the car lamp assembly, and a plurality of LEDs mounted on the main seat; the LEDs respectively having a light-emitting end oriented to the lens of the car lamp assembly, so that light beams emitted from the LEDs are transmitted from the light-emitting ends through the lens to external environment; and
at least one fan being connected to the base of the car lamp assembly and located in the closed chamber to force air in the closed chamber to flow and circulate therein.

2. The LED car lamp structure with demisting and dehumidifying functions as claimed in claim 1, wherein the main seat of the LED module has a heat sink externally connected thereto.

3. The LED car lamp structure with demisting and dehumidifying functions as claimed in claim 1, wherein the LED module and the fan are electrically connected to a controller.

4. The LED car lamp structure with demisting and dehumidifying functions as claimed in claim 2, wherein the LED module and the fan are electrically connected to a controller.

5. The LED car lamp structure with demisting and dehumidifying functions as claimed in claim 1, wherein the fan is selected from the group consisting of an axial fan and a centrifugal fan.

6. The LED car lamp structure with demisting and dehumidifying functions as claimed in claim 2, wherein the fan is selected from the group consisting of an axial fan and a centrifugal fan.

7. The LED car lamp structure with demisting and dehumidifying functions as claimed in claim 3, wherein the fan is selected from the group consisting of an axial fan and a centrifugal fan.

8. The LED car lamp structure with demisting and dehumidifying functions as claimed in claim 4, wherein the fan is selected from the group consisting of an axial fan and a centrifugal fan.

9. The LED car lamp structure with demisting and dehumidifying functions as claimed in claim 1, wherein the fan includes a frame and a blade assembly located in and rotatably connected to the frame.

10. The LED car lamp structure with demisting and dehumidifying functions as claimed in claim 5, wherein the fan includes a frame and a blade assembly located in and rotatably connected to the frame.

11. The LED car lamp structure with demisting and dehumidifying functions as claimed in claim 6, wherein the fan includes a frame and a blade assembly located in and rotatably connected to the frame.

12. The LED car lamp structure with demisting and dehumidifying functions as claimed in claim 7, wherein the fan includes a frame and a blade assembly located in and rotatably connected to the frame.

13. The LED car lamp structure with demisting and dehumidifying functions as claimed in claim 8, wherein the fan includes a frame and a blade assembly located in and rotatably connected to the frame.
